(19) United States
(12) Patent Application Publication
(10) Pub. No.: US 2003/0185973 A1
(43) Pub. Date: Oct. 2, 2003

(54) Water vapor plasma method of increasing the surface energy of a surface

(76) Inventors: Richard L. Crawley, Ann Arbor, MI (US); Lawrence F. Wilski, Macomb Township, MI (US)

Correspondence Address: MacMillan Sobanski & Todd, One Maritime Plaza, Fourth Floor, 720 Water Street, Toledo, OH, 43604-1853, US

(21) Appl. No.: 10/113,583

(22) Filed: Mar. 30, 2002

(51) Int. Cl. B05D 5/06; H05H 1/24

(52) U.S. Cl. 427/162; 427/569

(57) ABSTRACT

In a method of treating a surface normally susceptible to fogging, a gas plasma is applied to chemically modify and thereby increase the surface energy of the surface. The gas plasma includes at least 80% water vapor plasma by weight. The increased surface energy causes the surface to have reduced susceptibility to fogging. In a method of increasing the adhesion between a material and a surface, a gas plasma is applied to chemically modify and thereby increase the surface energy of the surface. The gas plasma includes at least 80% water vapor plasma by weight. The increased surface energy causes the surface to have increased adhesive properties relative to the material.

### BACKGROUND OF THE INVENTION

This invention relates in general to gas plasma processes, and in particular to methods of treating surfaces with a gas plasma.

Various types of surfaces are often susceptible to undesirable fogging. For example, under certain circumstances, some automotive headlamp reflectors exhibit a white or colored haze across areas of the reflector bowl. Different methods have been tried to prevent this fogging. Most of the anti-fogging methods involve spraying a topcoat onto the reflector bowl after the conventional manufacturing steps have been completed. Unfortunately, such methods require additional material and additional processing steps that add to the cost of the headlamp.

U.S. Pat. No. 6,007,875, assigned to Leybold Systems, describes a continuous process in which a topcoat to prevent fogging is applied to a headlamp reflector by plasma deposition in the same chamber that a plasma polymer coating is plasma deposited on the reflector. The topcoat is composed of a hydrocarbon portion and an electronegative functional group; a preferred topcoat is methanol. While the methanol topcoat does reduce fogging, it has been found that methanol and similar materials may cause undesirable etching of the plasma polymer coating, and may reduce the corrosion resistance of the reflector.

Another commercial anti-fogging process uses a silicon oxide slurry which is evaporated in the presence of oxygen to change the surface energy of the reflector. The silicon oxide process is relatively costly and messy, and it creates undesirable fumes.

In a typical process for the manufacture of an automotive headlamp, the headlamp reflector is first coated with a basecoat, then with a reflective metal such as aluminum, and then with a protective topcoat applied by plasma polymerization. The plasma polymer topcoat protects the metal coating from deterioration due to chemical attack from environmental conditions such as salt spray. The lens of the headlamp is then glued to the headlamp body. One problem with the application of the plasma polymer topcoat is that the glue for attaching the lens to the headlamp body often does not adhere well to the topcoat. To avoid this problem, the glue track on the headlamp body is masked to prevent the topcoat from covering the glue track. The masking step increases the cost of the manufacturing process.

Automotive headlamps can be manufactured primarily from plastic instead of metal and glass to save costs and reduce weight. A particularly cost-efficient manufacturing process for plastic headlamps is an in-mold assembly process. In this process, the plastic headlamp body and a clear plastic lens are formed and attached to each other inside a mold. Specifically, a molten plastic resin is introduced into the mold and allowed to harden to form the headlamp body. Next, a reflective metal coating is applied inside the mold over the basecoat. Lastly, a molten clear plastic is introduced into the mold to form the headlamp lens. When the plastic hardens, the rim of the plastic lens adheres to the rim of the headlamp body. The rim of the headlamp body is coated with the reflective metal, but the plastic of the lens adheres well to the metal coating. However, the plastic of the lens would not adhere well to the plasma polymer topcoat usually applied over the metal coating in other manufacturing processes to protect it from deterioration. Consequently, the in-mold assembly process does not usually allow the application of a plasma polymer topcoat over the metal coating.

### SUMMARY OF THE INVENTION

This invention relates to a method of increasing the surface energy of various surfaces. In a first embodiment of the invention, the method is used for treating a surface normally susceptible to fogging. In the method, a gas plasma is applied to chemically modify and thereby increase the surface energy of the surface. The gas plasma includes at least 80% water vapor plasma by weight. Preferably, the gas plasma consists essentially of water vapor plasma. The increased surface energy causes the surface to have reduced appearance of fogging. The gas plasma may be applied, for example, to a reflector of an automotive headlamp to reduce fogging of the reflector.

In a second embodiment of the invention, the method is used for increasing the adhesion between a material and a surface. In the method, a gas plasma is applied to chemically modify and thereby increase the surface energy of the surface. The gas plasma includes at least 80% water vapor plasma by weight. The increased surface energy causes the surface to have increased adhesive properties relative to the material. The material and the surface are brought into contact with each other to adhere the material to the surface. The gas plasma may be applied, for example, to a glue track of an automotive headlamp to improve the bonding of an adhesive to the glue track for connecting a lens to the headlamp body. In another example, the gas plasma is applied to a rim surface of a headlamp body to improve the adhesion of the rim surface to a molten plastic which forms a lens of the headlamp during an in-mold assembly process.

Various advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of an automotive headlamp of the prior art showing fogging of the headlamp reflector.

FIG. 2 is a flow chart of a method of coating an automotive headlamp reflector, and then treating the coated reflector with a water vapor plasma according to the invention to reduce its susceptibility to fogging.

FIG. 3 is an enlarged cross-sectional view of a portion of an automotive headlamp in which the reflector has been coated and then treated with water vapor plasma according to the invention.

FIG. 4 is a further enlarged view as in FIG. 3, schematically showing the surface of the coating having been chemically modified by the water vapor plasma treatment to increase its surface energy.

### DETAILED DESCRIPTION OF THE PREFERRED EMBODIMENTS

Referring now to the drawings, there is illustrated in FIG. 5 an automotive headlamp 10 of the prior art. The headlamp 10 includes a headlamp body 12 which is typically made from a high temperature plastic or metal material. The headlamp body 12 includes a reflector bowl 14, a bulb shield 21, and a glue track 16 for attaching the headlamp lens (not shown) to the headlamp body. The inner surface of the reflector bowl 14 comprises the headlamp reflector 18. As shown in the drawing, the reflector 18 exhibits a white or colored haze 20 known as fogging across areas of the reflector. The fogging may occur in different areas of the reflector, and the area(s) of fogging may be different shapes and sizes. Typically, fogging is a problem when a bulb shield is used. The bulb shield causes areas of the reflector to heat up, which causes those areas to be susceptible to fogging. The fogging detracts from the appearance of the headlamp.

The present invention provides a method of treating a surface normally susceptible to fogging, in order to cause the surface to have reduced susceptibility to fogging. Although a preferred embodiment of the method involves treating an automotive headlamp reflector to reduce fogging, the invention is applicable to any type of surface normally susceptible to fogging, such as glass doors, windows, and mirrors. Further, the invention is applicable to any type of automotive headlamp, such as headlamps made primarily from heat resistant plastic or metal materials, and headlamps of different shapes and sizes made for different types of automotive vehicles. The invention is also applicable to any type of headlamp reflector susceptible to fogging. Typically, the headlamp reflector includes an aluminum layer and a topcoat of a plasma polymer layer.

In a preferred embodiment, the method is used to treat an automotive headlamp manufactured primarily from plastic materials. Such headlamps typically include a headlamp body formed from a bulk molding compound. Bulk molding compounds are usually thermosetting plastic resins mixed with reinforcements, fillers, and other additives into viscous compounds suitable for compression or injection molding. Some typical thermosetting resins used in the bulk molding compounds include polyesters, phenolics, vinyl esters, and epoxies. The headlamp body is usually coated with a basecoat such as a resin. The basecoat is usually applied between about 5 micrometers and about 30 micrometers thick.

The headlamp reflector is then usually coated with a reflective metal in a process known as metallization. Typically, the reflective metal is aluminum, although other metals such copper, zinc, silver, or different alloys, are sometimes used. The reflective metal coating is usually applied between about 25 nanometers and about 150 nanometers thick. The reflective metal coating can be applied by any suitable method. Some typical metallization methods include vacuum evaporation, sputtering, and plating, which are well known to those skilled in the art.

As discussed above, a protective topcoat is usually deposited over the metal coating by plasma polymerization. The plasma polymer topcoat can be formed from any suitable materials, such as silicon-organic compounds that are sufficiently vaporizable, polyvinylidene dichloride, or polyethylene/vinyl alcohol. A preferred plasma polymer topcoat is formed from hexamethyldisiloxane (HMDSO). The plasma polymerization process can be conducted using any suitable apparatus. One suitable apparatus for conducting both the metallization and the plasma polymerization is a vacuum evaporation apparatus sold by Stokes Vacuum Inc., 5500 Tabor Rd., Philadelphia, Pa. 19120. Another suitable apparatus for conducting both the metallization and the plasma polymerization is a sputtering apparatus sold by Leybold Systems GmbH, Hanau, Germany, and disclosed in U.S. Pat. No. 6,007,875, issued Dec. 28, 1999 (incorporated by reference herein). These apparatuses include in-chamber plasma polymerization processes, i.e., the plasma polymer topcoat is deposited on the part in the same chamber that the metal layer is deposited on the part.

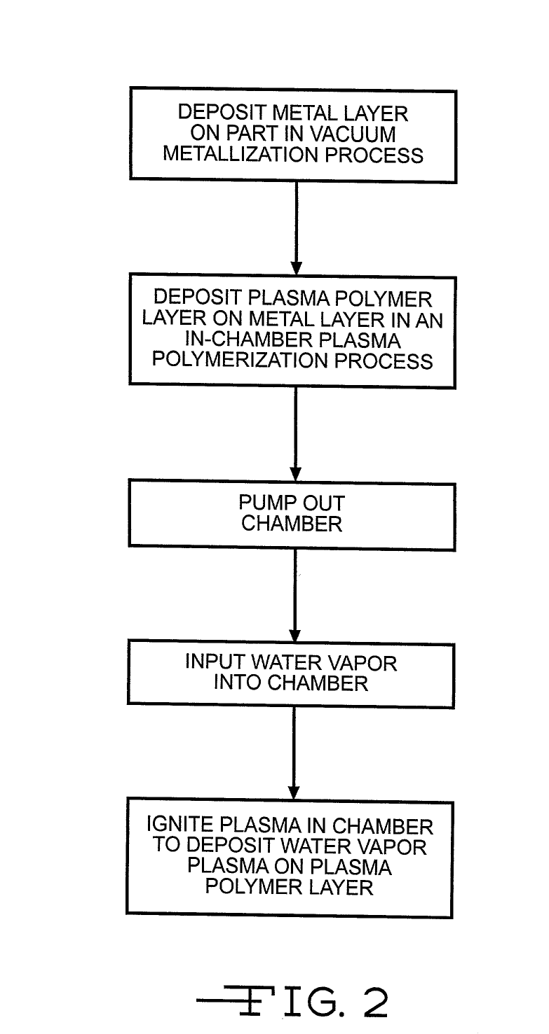

In a treatment according to the present invention to reduce the susceptibility of a surface to fogging, a gas plasma is applied to chemically modify and thereby increase the surface energy of the surface. The gas plasma includes at least about 80% water vapor plasma by weight. FIG. 2 is a flow chart of a preferred method of coating a part such as an automotive headlamp reflector, and then treating the coated part with a water vapor plasma according to the invention. In a first step of the method, a layer of metal such as aluminum is deposited on the part in a vacuum metallization process such as described above. In a second step, a plasma polymer layer is deposited on the metal layer in an in-chamber plasma polymerization process such as described above. In a third step, the atmosphere inside the chamber is pumped out. In a fourth step, water vapor is inputted into the chamber. In a fifth step, a plasma is ignited within the chamber to deposit the water vapor plasma on the plasma polymer layer. The water vapor plasma chemically modifies and thereby increases the surface energy of the plasma polymer layer.

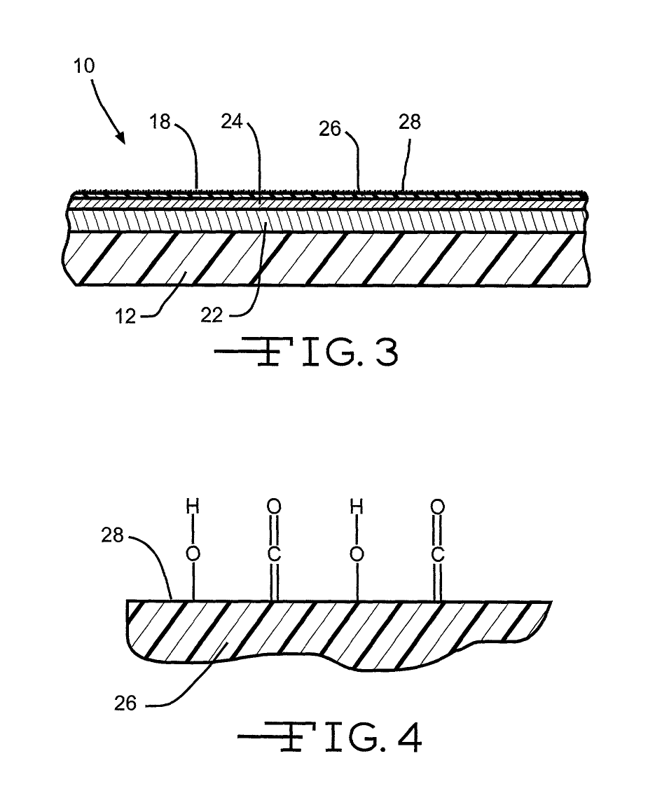

FIG. 3 shows an enlarged cross-section of a portion of an automotive headlamp 10 in which the reflector 18 has been coated and then treated with water vapor plasma as described above. The headlamp 10 includes a headlamp body 12. A layer of a basecoat 22 is deposited on the headlamp body. A layer of aluminum 24 is deposited on the basecoat. A layer of plasma polymerized HMDSO 26 is deposited on the aluminum layer. The outer surface 28 of the plasma polymer layer has been chemically modified by the water vapor plasma to increase its surface energy, as shown schematically by the roughened surface (the actual surface will be smooth). As further shown schematically in FIG. 4, the outer surface 28 of the plasma polymer layer 26 has been chemically modified by the addition of hydroxyl (—OH) and carbonyl (═C═O) functional groups to the surface to increase its surface energy.

As discussed above, the gas plasma applied to chemically modify the surface includes at least about 80% water vapor plasma by weight. Preferably, the gas plasma includes at least about 90% water vapor plasma by weight, and more preferably it consists essentially of water vapor plasma. It has been found that applying water vapor plasma to a surface such as a plasma polymer is a very effective method of chemically modifying the surface to increase its surface energy. Further, it has been found that increasing the surface energy by use of a water vapor plasma is a very effective method of reducing or eliminating the susceptibility to fogging of the surface. While not intending to be limited by theory, it is believed that increasing the surface energy of a surface does not stop vapors from condensing on the surface, but it allows the condensed vapors to spread out into larger drops or into continuous films which then do not scatter light and therefore do not become visible.

In contrast to the use of gas plasmas formed from methanol and other hydrocarbons such as disclosed in the Leybold Systems patent, the use of a water vapor plasma does not cause undesirable etching of the plasma polymer coating or reduce the corrosion resistance of the reflector. Preferably, the gas plasma contains substantially no hydrocarbon gas. Typically, the application of the gas plasma of the invention causes substantially no etching of a plasma polymer surface. Also, the process conditions of the treatment are usually sufficiently nonharmful to the surface such that a test surface of 50 nanometers thick aluminum coated with 17 nanometers thick plasma polymerized hexamethyldisiloxane shows no visible signs of corrosion or degradation after the treatment and after immersion in water at 32° C. for four days. Further, in contrast to the use of a silicon oxide to change the surface energy, the use of a water vapor plasma is cheap and clean, and it creates no undesirable fumes. A method using a water vapor plasma is safe, fast, and easy to implement.

Preferably, the application of the gas plasma to chemically modify the surface increases the surface energy by at least about 10 dynes/cm², and more preferably at least about 20 dynes/cm². Typically, the increased surface energy is at least about 38 dynes/cm², and often it is at least about 50 dynes/cm². The surface energy is measured using Accudyne ink pens, as is commonly known to the industry.

The surface can be chemically modified in any suitable manner to increase the surface energy. The chemical modification used to increase the surface energy will generally depend on the type of surface. In a preferred embodiment where the surface is a plasma polymer such as HMDSO, the surface is chemically modified to add functional groups selected from the group consisting of —OH groups, ═C═O groups, and combinations thereof. Some nonlimiting examples of other ways to chemically modify a surface include nitridation, siliciation, or, titaniation.

The gas plasma can be applied to the surface by any suitable method. Methods of forming gas plasmas are well known in the art. U.S. Pat. No. 6,106,653 assigned to Exxon, issued Aug. 22, 2000 (incorporated by reference herein), describes a method of forming a water vapor plasma. The initiation of a discharge within a chamber containing water vapor excites the water molecules to develop a water vapor plasma which comprises a mix of positively and negatively charged water molecules. The water vapor plasma is reactive with the surface to be treated to cause chemical modification of the surface. Preferably, the application of the gas plasma is conducted at a pressure between about 2 millitorr and about 40 millitor, at an excitation power between about 10 watts and about 2000 watts, and for a time between about 10 seconds and about 200 seconds, depending on the chamber dimensions.

The gas plasma can be applied to the surface using any suitable apparatus. Preferably, the surface to be treated has been deposited on a substrate inside a chamber in a plasma polymerization process, and the gas plasma including at least about 80% water vapor plasma is applied to the surface inside the same chamber. The above-described Leybold Systems patent discloses a preferred apparatus for plasma polymerization and gas plasma treatment of a surface inside the same chamber. Another type of apparatus suitable for applying the gas plasma includes a modified Stokes metallizer. The modification involves the addition of a vaporizer for water, a heated second feed gas line, 3 way valve, and condensable vapor flow controller, and additions to the process flow software program.

In another embodiment, the invention relates to a method of increasing the adhesion between a material and a surface. In the method, a gas plasma is applied to chemically modify and thereby increase the surface energy of the surface. The gas plasma includes at least 80% water vapor plasma by weight. The increased surface energy causes the surface to have increased adhesive properties relative to the material. The material and the surface are brought into contact with each other to adhere the material to the surface.

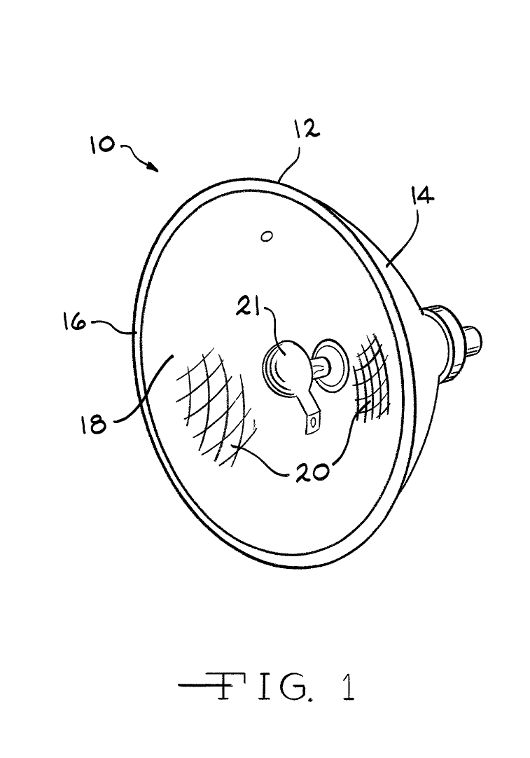

The method can be used for increasing the adhesion between many different types of materials and many different surfaces. Some nonlimiting examples include low surface energy polyolefins and silicones with urethanes and epoxies. In one preferred embodiment, the gas plasma is applied to a glue track of an automotive headlamp (such as the glue track 16 shown in FIG. 1) to improve the bonding of an adhesive to the glue track for connecting a lens to the headlamp body. As discussed above, in a typical process for the manufacture of an automotive headlamp, the headlamp reflector is first coated with a basecoat, then with a reflective metal such as aluminum, and then with a protective topcoat applied by plasma polymerization. The lens of the headlamp is then glued to the headlamp body. One problem with the application of the plasma polymer topcoat is that the adhesive for attaching the lens to the headlamp body often does not adhere well to the topcoat. To avoid this problem, the glue track on the headlamp body is masked to prevent the topcoat from covering the glue track, which increases the cost of the manufacturing process. The method of the present invention avoids the need for masking by increasing the surface energy of the topcoat so that it adheres better to the adhesive used to attach the lens to the headlamp body. Some typical examples of adhesives used to attach a headlamp lens include two-part urethanes and hot melt olefins.

The method substantially increases the adhesion between the surface and the material. Using the above-described headlamp glue track as an example, the surface (the plasma polymer topcoat) is an outer surface which has been deposited on an inner surface (the metal layer). The material (the adhesive) has a base strength of adhesion to the metal layer, but the adhesive has a strength of adhesion to the plasma polymer topcoat which is not greater than about 70% of the base strength before applying the gas plasma. However, after applying the gas plasma, preferably the adhesive has a strength of adhesion to the plasma polymer topcoat which is at least about 80% of the base strength, and more preferably at least about 90%.

In another preferred embodiment, the material is a molten material, and the material is caused to contact the surface during an in-mold assembly process. In a specific embodiment, the gas plasma is applied to at least the rim surface of a headlamp body to improve the adhesion of the rim surface to a molten plastic which forms a lens of the headlamp during an in-mold assembly process (not shown). As discussed above, in a typical in-mold assembly process for manufacturing plastic headlamps, the rim of the headlamp body is coated with a reflective metal. The injected plastic of the lens adheres well to the metal coating, but the plastic would not adhere well to a plasma polymer topcoat usually applied over the metal coating in other manufacturing processes. Consequently, the in-mold assembly process does not usually allow the application of a plasma polymer topcoat over the metal coating. The method of the present invention allows the application of a plasma polymer topcoat over the metal coating during an in-mold assembly process by increasing the adhesion of the topcoat so that it adheres well to the plastic of the lens.

### EXAMPLE 1

A 7″ round headlamp body had been formed from a bulk molding compound (BMC) and coated with a basecoat, and the reflector had been coated with a layer of aluminum and then topcoated with hexamethyldisiloxane (HMDSO) by plasma polymerization. The reflector had a surface energy of about 34 dynes/cm². In a sputter deposition coater, the reflector was subjected to a water vapor plasma at 50 mtorr pressure, 10 watts 13.56 Mhz for 1 minute, resulting in an increase in surface energy to about 50 dynes/cm². This reflector was subjected to over 90 hours of high beam illumination at 13.8 volts without producing any substantial appearance of fogging. The headlamp body was then glued to the lens and re-illuminated for over 200 hours with only minimal fogging occurring.

### EXAMPLE 2

A 7″ round headlamp body had been formed from BMC and coated with a basecoat, and the reflector had been coated with a layer of aluminum and then topcoated with HMDSO by plasma polymerization. The reflector had a surface energy of less than 30 dynes/cm². In a sputter deposition coater, the reflector was subjected to a water vapor plasma at 35 mtorr pressure, 7 watts 13.56 Mhz for 1 minute, resulting in an increase in surface energy to about 58 dynes/cm². This reflector was subjected to over 90 hours of high beam illumination at 12.8 volts without producing any substantial appearance of fogging. The headlamp body was then glued to the lens and re-illuminated for over 200 hours with only minimal fogging occurring.

### EXAMPLE 3

A 7″ round headlamp body had been formed from BMC and coated with a basecoat. In a Stokes vacuum evaporation metallizer, the reflector of the headlamp body was metallized with aluminum and then topcoated with HMDSO by plasma polymerization in the same chamber as the metallization. The reflector had a surface energy of less than 30 dynes/cm². When subjected to illumination at 12.8 volts, the reflector fogged badly after 20 minutes.

### EXAMPLE 4

A 7″ round headlamp body had been formed from BMC and coated with a basecoat. In a Stokes vacuum evaporation metallizer, the reflector of the headlamp body was metallized with aluminum and then in-chamber topcoated with HMDSO by plasma polymerization. In the same chamber, the reflector was then subjected to water vapor plasma at 8 mtorr pressure, 550 watts a-c glow discharge (1900 volts, 0.3 amps) for 1 minute. This resulted in a reflector surface energy of slightly greater than 44 dynes/cm². When illuminated with a high beam at 13.8 volts, this headlamp ran for 24 hours ending with no substantial fog on the reflector, although early on a flash of fog was seen which subsequently vanished.

### EXAMPLE 5

A 7″ round headlamp body had been formed from BMC and coated with a basecoat. In a Stokes vacuum evaporation metallizer, the reflector of the headlamp body was metallized with aluminum and then in-chamber topcoated with HMDSO by plasma polymerization. In the same chamber, the reflector was then plasma treated with water vapor at 20 mtorr pressure, 550 watts 20 kHz a-c power for 1 minute, producing a surface with above 44 dynes/cm² surface energy. When illuminated with a high beam at 13.8 volts, this headlamp ran for over 100 hours without displaying any significant amount of fogging of the reflector.

### EXAMPLE 6

A 7″ round headlamp body had been formed from BMC and coated with a basecoat. In a Stokes vacuum evaporation metallizer, the headlamp body was metallized with aluminum and then in-chamber topcoated with HMDSO by plasma polymerization. In the same chamber, the headlamp body was then subjected to water vapor plasma at 6 mtorr pressure, 550 watts a-c power for 1 minute. The final surface energy was about 37 dynes/cm². This headlamp was illuminated for 19 hours continuous high beam at 13.8 volts, resulting in a moderated light yet still objectionable level of fog.

### EXAMPLE 7

Testing was conducted to determine the effect of water vapor plasma treatment on the adhesion of headlamp reflector surfaces. In a sputter deposition coater, 100 1″×4″ flat plaques of basecoated BMC were coated with aluminum and then HMDSO as typical for headlamp reflectors. The surface energy was found to be less than 30 dynes/cm², typical of Al/HMDSO metallized automotive reflectors. In the same coater, 75 flat plaques of basecoated BMC were aluminum and HMDSO coated, and then plasma treated with water vapor at 6 to 8 mtorr pressure, 75 watts 13.56 Mhz R-F energy for 1 minute. This resulted in a surface energy of greater than 58 dynes/cm².

All the plaques were then glued to flat plaques of polycarbonate transparent headlamp lens material, using standard automotive 2-part urethane adhesive. After a full 7-day room temperature cure, the plaques were pull tested using standard methods. It was found that the standard Al/HMDSO coated plaques adhesion failed at the adhesive/HMDSO interface, due to poor adhesion of the glue to the low surface energy HMDSO. It was also found that none of the water vapor plasma treated plaques failed at the interface, but instead held together till much higher pull strength, eventually failing at the basecoat/BMC interface. This indicated that the water vapor plasma treated HMDSO surface adhered well to the adhesive glue bonding.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A method of treating a surface normally susceptible to fogging, the method comprising:
applying a gas plasma to chemically modify and thereby increase the surface energy of the surface, the gas plasma including at least about 80% water vapor plasma by weight, the increased surface energy causing the surface to have reduced susceptibility to fogging.

2. A method according to claim 1 wherein the gas plasma is applied to a surface of a reflector of an automotive headlamp.

3. A method according to claim 1 wherein the gas plasma contains substantially no hydrocarbon gas.

4. A method according to claim 1 wherein the gas plasma consists essentially of water vapor plasma.

5. A method according to claim 1 wherein the surface energy is increased by at least about 10 dynes/cm².

6. A method according to claim 1 wherein the increased surface energy is at least about 38 dynes/cm².

7. A method according to claim 1 wherein the surface comprises a plasma polymer.

8. A method according to claim 7 wherein the plasma polymer surface is chemically modified to add functional groups selected from the group consisting of —OH groups, ═C═O groups, and combinations thereof.

9. A method according to claim 7 wherein the application of the gas plasma causes substantially no etching of the plasma polymer surface.

10. A method according to claim 1 wherein the surface has been deposited on a substrate inside a chamber in a plasma polymerization process, and wherein the gas plasma including at least about 80% water vapor plasma is applied to the surface inside the same chamber.

11. A method according to claim 1 wherein the application of the gas plasma is conducted at a pressure between about 2 millitorr and about 40 millitor, at an excitation power between about 10 watts and about 2000 watts, and for a time between about 10 seconds and about 200 seconds.

12. A method according to claim 1 wherein the process conditions of the treatment are sufficiently nonharmful to the surface such that a test surface of 50 nanometer thick aluminum coated with at least 17 nanometer thick plasma polymerized hexamethyldisiloxane shows no visible signs of corrosion or degradation after the treatment and after immersion in water at 32° C. for four days.

13. A method of increasing the adhesion between a material and a surface, the method comprising:
applying a gas plasma to chemically modify and thereby increase the surface energy of the surface, the gas plasma including at least about 80% water vapor plasma by weight, the increased surface energy causing the surface to have increased adhesive properties relative to the material; and
causing contact between the material and the surface to adhere the material to the surface.

14. A method according to claim 13 wherein the material comprises an adhesive.

15. A method according to claim 13 wherein the surface comprises a plasma polymer.

16. A method according to claim 13 wherein the surface comprises a glue track of an automotive headlamp.

17. A method according to claim 13 wherein the material comprises a molten material.

18. A method according to claim 17 wherein the material is caused to contact the surface during an in-mold assembly process.

19. A method according to claim 18 wherein the surface is a rim of an automotive headlamp body, and wherein the material comprises a molten plastic which forms a lens of the headlamp.

20. A method according to claim 13 wherein the surface is an outer surface which has been deposited on an inner surface, wherein the material has a base strength of adhesion to the inner surface, wherein the material has a strength of adhesion to the outer surface which is not greater than about 70% of the base strength before applying the gas plasma, and wherein the material has a strength of adhesion to the outer surface which is at least about 80% of the base strength after applying the gas plasma.

21. A method according to claim 20 wherein the outer surface has been deposited on the inner surface inside a chamber in a plasma polymerization process, and wherein the gas plasma including at least about 80% water vapor plasma is applied to the outer surface inside the same chamber.
